(19) United States
(12) Patent Application Publication
(10) Pub. No.: US 2020/0091730 A1
(43) Pub. Date: Mar. 19, 2020

(54) SELF-POWERED ENERGY HARVESTING CIRCUIT

(71) Applicant: uBeam Inc., Marina del Rey, CA (US)

(72) Inventors: Hong Gao, Marina del Rey, CA (US); Jonathan Bolus, Santa Monica, CA (US)

(21) Appl. No.: 16/691,535

(22) Filed: Nov. 21, 2019

Related U.S. Application Data
(63) Continuation-in-part of application No. 16/687,601, filed on Nov. 18, 2019.
Application No. 16/687,601 is a continuation of application No. 15/885,493, filed on Jan. 31, 2018, now Pat. No. 10,483,766.
Application No. 15/885,493 is a division of application No. 15/665,074, filed on Jul. 31, 2017, now Pat. No. 9,912,165.
Application No. 15/665,074 is a continuation-in-part of application No. 15/132,074, filed on Apr. 18, 2016, now Pat. No. 9,954,373.

(51) Int. Cl. H02J 5/00; H02M 7/217; H02J 1/10; H02J 1/00; H02J 50/15; H02J 1/12; H02J 7/34

(52) U.S. Cl. CPC H02J 5/00; H02M 7/2176; H02J 1/108; H02J 1/102; H02M 1/32; H02J 50/15; H02J 1/12; H02J 7/345; H02J 1/00

(57) ABSTRACT

Systems and techniques are provided for a self-powered energy harvesting circuit. A power generating mechanism may include power generating elements that generate alternating current signals. Rectifier circuits may each include a rectifier that generates a direct current signal from an alternating current signal. Group circuits may connect a group of the rectifier circuits in an electrical circuit to combine the direct current signals from the rectifier circuits in the group into a single direct current signal. Energy storage devices may be connected to the group circuits. The outputs of energy storage devices may be combined into a single output. The single output split into a primary output and a secondary output. A switch may be connected to the primary output. A controller may be connected to the secondary output and to the switch. The controller may control the switch. A voltage regulator may be connected to an output of the switch.

### BACKGROUND

Some power generating mechanisms may generate small amounts of power. It may be difficult to operate a device that requires larger amounts of power from these types of power generating mechanisms.

### BRIEF SUMMARY

According to implementations of the disclosed subject matter, a power generating mechanism may include power generating elements that generate alternating current signals. Rectifier circuits may each include a rectifier that generates a direct current signal from an alternating current signal. Group circuits may connect a group of the rectifier circuits in an electrical circuit to combine the direct current signals from the rectifier circuits in the group into a single direct current signal. Energy storage devices may be connected to the group circuits. The outputs of energy storage devices may be combined into a single output. The single output split into a primary output and a secondary output. A switch may be connected to the primary output. A controller may be connected to the secondary output and to the switch. The controller may control the switch. A voltage regulator may be connected to an output of the switch.

Systems and techniques disclosed herein may allow for a self-powered energy harvesting circuit. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example system suitable for a self-powered energy harvesting circuit according to an implementation of the disclosed subject matter.

FIG. 2 shows an example system suitable for a self-powered energy harvesting circuit according to an implementation of the disclosed subject matter.

FIG. 3A shows an example system suitable for a self-powered energy harvesting circuit according to an implementation of the disclosed subject matter.

FIG. 3B shows an example system suitable for a self-powered energy harvesting circuit according to an implementation of the disclosed subject matter.

FIG. 4A shows an example system suitable for a self-powered energy harvesting circuit according to an implementation of the disclosed subject matter.

FIG. 4B shows an example system suitable for a self-powered energy harvesting circuit according to an implementation of the disclosed subject matter.

FIG. 5 shows an example system suitable for a self-powered energy harvesting circuit according to an implementation of the disclosed subject matter.

FIG. 6 shows an example system suitable for a self-powered energy harvesting circuit according to an implementation of the disclosed subject matter.

FIG. 7 shows an example arrangement suitable for a self-powered energy harvesting circuit according to an implementation of the disclosed subject matter.

FIG. 8 shows a computer according to an embodiment of the disclosed subject matter.

FIG. 9 shows a network configuration according to an embodiment of the disclosed subject matter.

### DETAILED DESCRIPTION

According to embodiments disclosed herein, a self-powered energy harvesting circuit may be used to harvest energy from power generating mechanisms. The self-powered energy harvesting circuit may include energy storage devices which may accumulate small amounts of energy from power generated by a power generating mechanism. The energy storage devices may be disconnected from an electrical load using a switch until the amount of stored energy in the energy storage devices reaches a predetermined level. The energy storage devices may then be connected to the electrical load using the switch, burst-charge the electrical load, and subsequently be disconnected from the electrical load using the switch. The energy storage devices may again accumulate small amounts of energy from power generated by the power generating mechanism. The switch may be controlled by a controller which may be powered by the electrical storage devices. The energy storage devices, switch, and controller may be components of the self-powered energy harvesting circuit. This may allow the smaller amounts of power generated by the power generating mechanism to be used to supply an electrical load that may need a larger amount of energy at set duty cycles.

A power generating mechanism may be used to generate power. The power generating mechanism may be, for example, an array of power generating elements. For example, the power generating mechanism may be a transducer array, such as an optical transducer array or an ultrasonic transducer array including any suitable number of ultrasonic transducer elements, or a radio frequency (RF) receiver. The power generating elements may be transducer elements, such as, for example, ultrasonic transducers. Each power generating element may generate an alternating current signal of varying amplitude, and amplitudes and phases of the alternating current signals generated by different power generating elements may vary, resulting in alternating current signals of varying voltages. For example, ultrasonic transducer elements of an ultrasonic transducer array may generate alternating current signals based on the movement of a flexure, such as a piezoelectric flexure, in response to received ultrasound waves. The amplitude of the alternating current signals generated by an ultrasonic transducer element may vary as the amplitude of the ultrasonic waves received by the ultrasonic transducer element change. Different ultrasonic transducer elements in the same ultrasonic transducer array may generate alternating current signals with different amplitudes, resulting in the alternating current signals having different voltages. The alternating current signals may have various phase shifts relative to each other. The amount of power generated by an individual power generating element may be small.

The power generating mechanism may be connected to a rectifier array. The rectifier array may include any suitable number of rectifiers which may be connected to the power generating elements of the power generating mechanism in any suitable manner. For example, there may be one rectifier for each power generating element in the power generating mechanism. The rectifiers of the rectifier array may be AC/DC rectifiers of any suitable type. The rectifiers may be full-wave bridge rectifiers with differential inputs. The rectifiers may use a diode bridge, Schottky diodes, diode-connected FETS, or may be any form of synchronous rectifier. Each rectifier may, for example, receive the alternating current signal from a different power generating element and may output a direct current signal of any suitable voltage.

The rectifier array may be connected to an energy collection pool. The energy collection pool may include any suitable number of energy storage devices of any suitable type. The energy storage devices may be, for example, capacitors, super capacitors, or batteries. The rectifiers of the rectifier array may be connected to the energy storage devices in the energy collection pool in any suitable manner. For example, a circuit may be used to combine the direct current signal outputs of multiple rectifiers into a single direct current signal input for an energy storage device. The output of the rectifiers may be combined, for example, in parallel. The rectifier array may include 256 rectifiers. The outputs of the rectifiers may be combined in groups of four, resulting in 64 direct current signal outputs from the rectifier array that may connect to 64 inputs for energy storage devices in the energy collection pool. The energy storage devices of the energy collection pool may store energy from the direct current signals received from the rectifier array. For example, the direct current signals may charge capacitors, super capacitors, and/or batteries of the energy collection pool.

The energy collection pool may be connected to a controller and a switch. The energy collection pool may include single output that may be split into a primary output and secondary output. The outputs of the energy storage devices of the energy collection pool may be combined in parallel into a direct current signal for the single output, which may then be split to the primary output and the secondary output. The primary output may be connected to the switch and the secondary output may be connected to the controller.

The controller may be connected to the switch. The controller may be any suitable controller or microcontroller, and may be powered by the direct current signal from the secondary output of the energy collection pool. A linear regulator may be used to convert the direct current signal of the secondary output of the energy collection pool to a direct current signal having a native voltage level for the controller. The controller may be able to measure the amount of energy stored in the energy storage devices of the energy collection pool, for example, through measuring the voltage or amperage of the direct current signal from the secondary output from the energy collection pool. The controller may cause the switch to close when the amount of energy stored in the energy storage devices of the energy collection pool has reached a predetermined level of stored energy, and may cause the switch to open when the energy storage devices of the energy collection pool have discharged down to a second predetermined level of stored energy.

The switch may be connected to a voltage regulator. The voltage regulator may be of any suitable type, and may have an output of any suitable voltage. The voltage regulator may be, for example, a linear regulator or a switching regulator. The output of the voltage regulator may be based on, for example, an electrical load connected to the output of the voltage regulator. For example, the electrical load may be a battery for a smartphone which charge at 5 Volts. The voltage regulator may regulate the voltage of an electrical signal received from the switch to 5 Volts in order to charge the battery of the smartphone. When the switch is closed, a direct current signal from the primary output of the energy collection pool may carry energy from the energy storage devices of the energy collection pool through the closed switch to the voltage regulator. The output of the voltage regulator while the switch is closed may be a direct current signal with a voltage level and current determined by the voltage regulator that may be used to burst charge an electrical load connected to the output of the voltage regulator.

The self-powered electrical harvesting circuit may be implemented using any suitable combination of hardware and software. For example, components of the self-powered electrical harvesting may be implemented in whole or in part as a field programmable gate array (FPGA) or application-specific integrated circuit (ASIC) or complex programmable logic device (CPLD), or using integrated circuit packages. Components of the self-powered electrical harvesting may be connected in any suitable manner. For example, connections between components may be implemented as traces on PCB, or using any other suitable type of electrical connection for carrying alternating current signals and direct current signals. Voltage levels of direct current signals may be approximate, or within suitable ranges of specified voltage levels. For example, the direct signal output at the target voltage level may vary in any suitable range around the target voltage level.

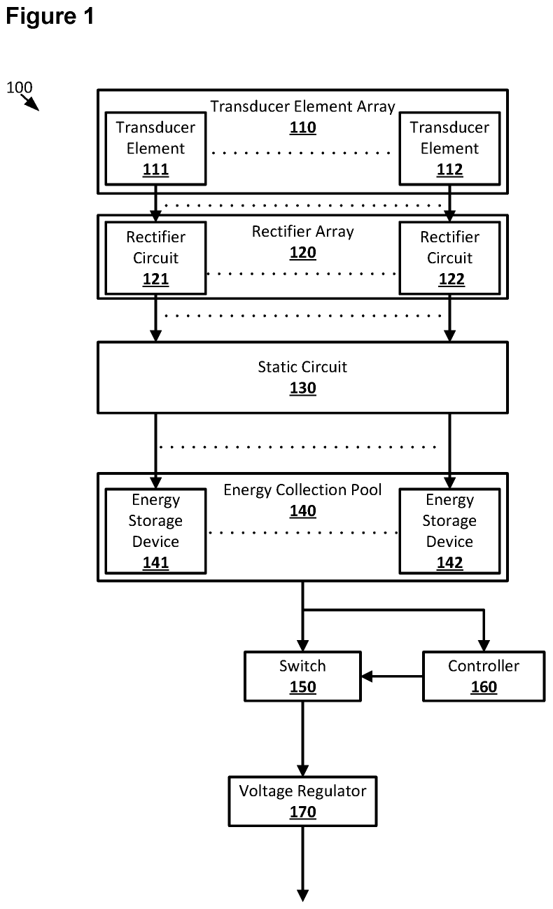

FIG. 1 shows an example system suitable for a self-powered energy harvesting circuit according to an implementation of the disclosed subject matter. A self-powered energy harvesting circuit 100 may include a transducer element array 110, a rectifier array 120, a static circuit 130, an energy collection pool 140, a switch 150, a controller 160, and a voltage regulator 170. The self-powered energy harvesting circuit 100 may be able to receive power transmitted wirelessly, for example, through optical, ultrasonic, or RF transmission, using the transducer element array 110.

The transducer element array 110 may be a power generating mechanism for the self-powered energy harvesting circuit 100. The transducer element array 110 may include any number of transducer elements, such as the transducer elements 111 and 112. The transducer elements 111 and 112 may be any suitable type of transducers for receiving power transmitted wirelessly in any suitable form. For example, the transducer elements 111 and 112 may be ultrasonic transducers, which may convert ultrasonic sound waves into AC. The transducer element array 110 may have a number of outputs for current equal to the number of elements in the transducer element array 110. The elements of the transducer element array 110 may each output current to a rectifier circuit, such as the rectifier circuits 121 and 122, of the rectifier array 120. The self-powered energy harvesting circuit 100 may include one rectifier circuit for each transducer element. Each rectifier circuit of the rectifier array 120 may include a single DC output. The current carried by the outputs of the rectifier circuits may be DC, converted from the AC input into the rectifier circuits from the transducer elements of the transducer element array 110.

The rectifier circuits may output current into the static circuit 130. The static circuit 130 may combine, in parallel or in series, the currents output from the rectifier circuits, such as the rectifier circuits 121 and 122. The currents may be combined in any suitable manner. For example, the static circuit 130 may combine the currents output from separate groups of rectifier circuits, with each group of rectifier circuits having its own separate output from the static circuit 130. The current carried by the outputs of the static circuit 130 may be DC.

The energy collection pool 140 may include a number of energy storage devices, such as the energy storage devices 141 and 142. The energy collection pool 140 may include any suitable number of energy storage devices, including, for example a number equal to the number of outputs from the rectifier array 120. For example, if the rectifier array 120 has 64 outputs for DC current from the rectifier circuits, the energy collection pool 140 may include 64 energy storage devices. The energy collection pool 140 may also include fewer energy storage devices that the number of outputs from the rectifier array 120, and may combine outputs from the rectifier array 120 as inputs to energy storage devices of the energy collection pool 120. Outputs of the energy storage devices of the energy collection pool 120 may be combined into a single output that carries DC current. The outputs from the energy storage devices may be combined in parallel or in serial. The single output from the energy collection pool 140 may be split into a primary output and a secondary output.

The switch 150 may be connected to the primary output of the energy collection pool 140. When the switch 150 is closed, DC current from the primary output of the energy collection pool 140 may pass through the closed switch 150 to the voltage regulator 170. When the switch 150 is open, no current may flow though the switch 150 to the voltage regulator 170.

The voltage regulator 170 may convert DC received from the energy collection pool 140 through the switch 150 to a DC of a voltage level suitable for an electrical load connected to the voltage regulator 170. The electrical load may be, for example, a battery such a lithium-ion battery in an electronic device such as a smartphone, smartwatch, sensor, or other suitable electronic device. The voltage regulator 170 may, for example, output a 5V DC current from an input of a DC current of any voltage output from the energy collection pool 140 through the switch 150.

The controller 160 may operate using DC current from the secondary output of the energy collection pool 140. The controller 160 may monitor the energy storage levels of the energy storage devices in the energy collection pool 140, for example, through measuring the voltage and/or amperage of the secondary output before the current of the secondary output is converted to a voltage level used to operate the controller 160. The controller 160 may operate the switch 150. For example, the controller 160 may close the switch when the energy storage level of the energy storage devices of the energy collection pool 140 reaches a predetermined level, burst-charging an electrical load connected to the voltage regulator 170. The controller 160 may open the switch when the energy storage level of the energy storage devices of the energy collection pool 140 falls to a second predetermined level due to discharging of energy into the electrical load.

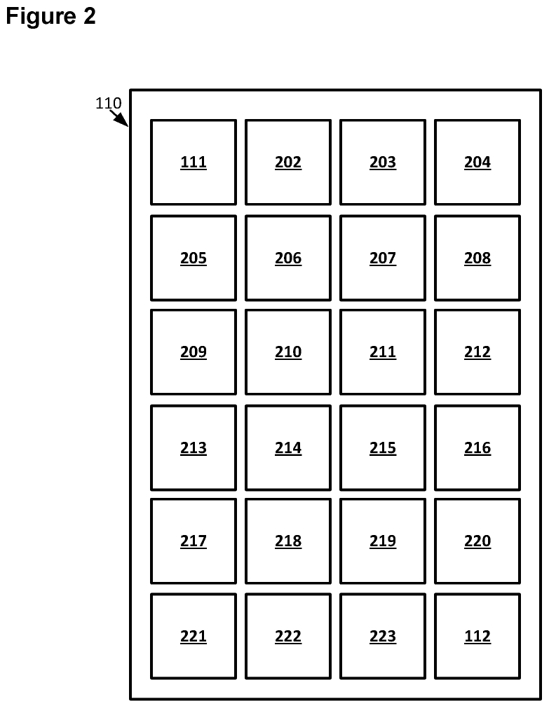

FIG. 2 shows an example system suitable for a self-powered energy harvesting circuit according to an implementation of the disclosed subject matter. The transducer element array 110 may include transducer elements 111, 202, 203, 204, 205, 206, 207, 208, 209, 210, 211, 212, 213, 214, 215, 216, 217, 218, 219, 220, 221, 222, 223, and 112, which may be any suitable type of transducers for receiving power transmitted wirelessly in any suitable form. For example, the transducer elements 111, 202 to 224, and 112 may be ultrasonic transducers, which may convert ultrasonic sound waves into AC.

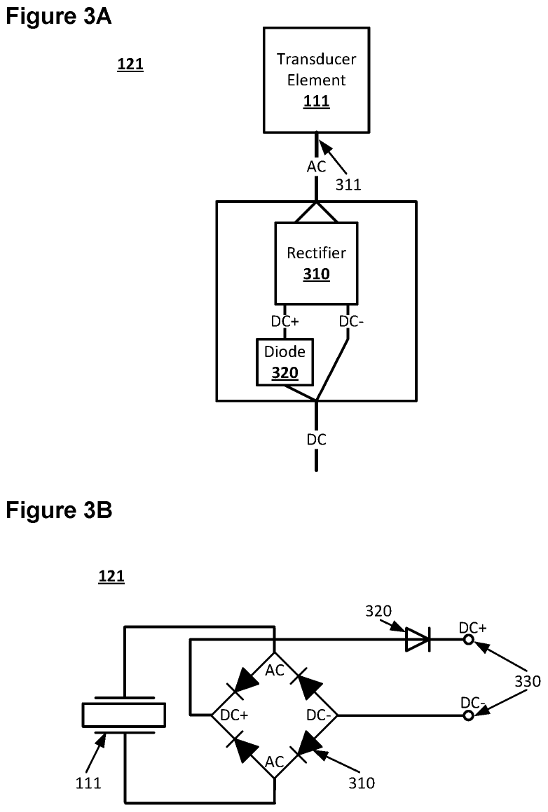

FIG. 3A shows an example system suitable for a self-powered energy harvesting circuit according to an implementation of the disclosed subject matter. The output 311 of the transducer element 111 may carry AC to the rectifier circuit 121. The output 311 may be connected to a rectifier 310 of the rectifier circuit 121. The rectifier 310 may convert the AC carried by the output 311 to DC. The rectifier 310 may use a diode bridge, Schottky diodes, diode-connected FETS, or may be any form of synchronous rectifier. A diode 320 may be connected to one side of the DC output of the rectifier 310. For example, the diode 320 may be connected to the positive side of the DC output of the rectifier 310. The diode 320 may be any suitable diode, connected in any suitable manner. The diode 320 may allow the DC outputs of multiple rectifier circuits to be combined, for example, in parallel, without dropping the voltage of the combined DC output to the lowest individual DC voltage output by one of the multiple rectifier circuits.

FIG. 3B shows an example system suitable for a self-powered energy harvesting circuit according to an implementation of the disclosed subject matter. The rectifier 310 of the rectifier circuit 121 may be, for example, a bridge rectifier. The rectifier 310 may be connected to the AC output leads from a transducer element 111, and may output DC to positive and negative DC output leads 330. The diode 320 may be attached to one of the DC output leads 330, for example, the positive DC lead.

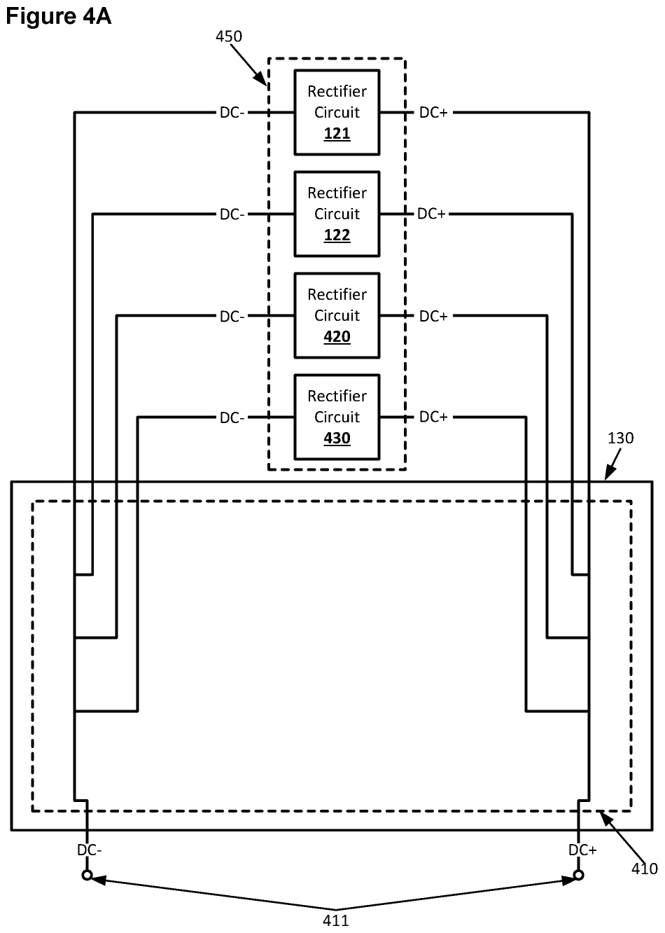

FIG. 4A shows an example system suitable for a self-powered energy harvesting circuit according to an implementation of the disclosed subject matter. The rectifier circuits, such as the rectifier circuits 121 and 122, may be connected to the static circuit 130. The static circuit 130 may include a separate group circuit, such as the group circuit 410 for each group of rectifier circuits of the rectifier array 120, such as group 450 including the rectifier circuits 121, 122, 420, and 430. A group of the rectifier array 120, such as the group 450, may include any suitable number of rectifier circuits. The group circuit 410 may connect the outputs of the rectifier circuits 121, 122, 420, and 420 of the group 450 in parallel. The combined output of the group 450 may be output from the static circuit 130 using the output 411 from the group circuit 410. The output 411 may carry current that is the combination of the DC generated by each of the rectifier circuits 121, 122, 420, and 420 of the group 450. Each group circuit of the static circuit 130 may include its own output, so that the number of outputs, such as the output 311, from the static circuit 130 may be equal to the number of transducer elements of the transducer element array 110, which may be the same as the number of rectifier circuits, divided by the number of rectifier circuits per group. In some implementations, groups may have different numbers of rectifier circuits, but the static circuit 130 may still include one output per group regardless of the number of rectifier circuits in each group. The static circuit 130 may be implemented in any suitable manner. For example, the static circuit 130 may be implemented with traces on any number of layers of a PCB which may include the transducer element array 110 and may also include the rectifier circuits, such as the rectifier circuits 121, 122, 420, and 430. The outputs from rectifier circuits may be electrically connected to the static circuit in any suitable manner. For example, traces and vias may be used to route connections through any number of layers of a PCB to connect each of the rectifier circuits to its group circuit in the static circuit 130.

FIG. 4B shows an example system suitable for a self-powered energy harvesting circuit according to an implementation of the disclosed subject matter. The rectifier circuits, such as the rectifier circuits 121 and 122, may be connected to the static circuit 130. The static circuit 130 may include a separate group circuit, such as the group circuit 410 for each group of rectifier circuits, such as group 450 including the rectifier circuits 121, 122, 420, and 430. A group, such as the group 450, may include any suitable number of rectifier circuits. The group circuit 410 may connect the outputs of the rectifier circuits 121, 122, 420, and 420 of the group 450 in series. The combined output of the group 450 may be output from the static circuit 130 using the output 411 from the group circuit 410. The output 411 may carry current that is the combination of the DC generated by each of the rectifier circuits 121, 122, 420, and 420 of the group 450.

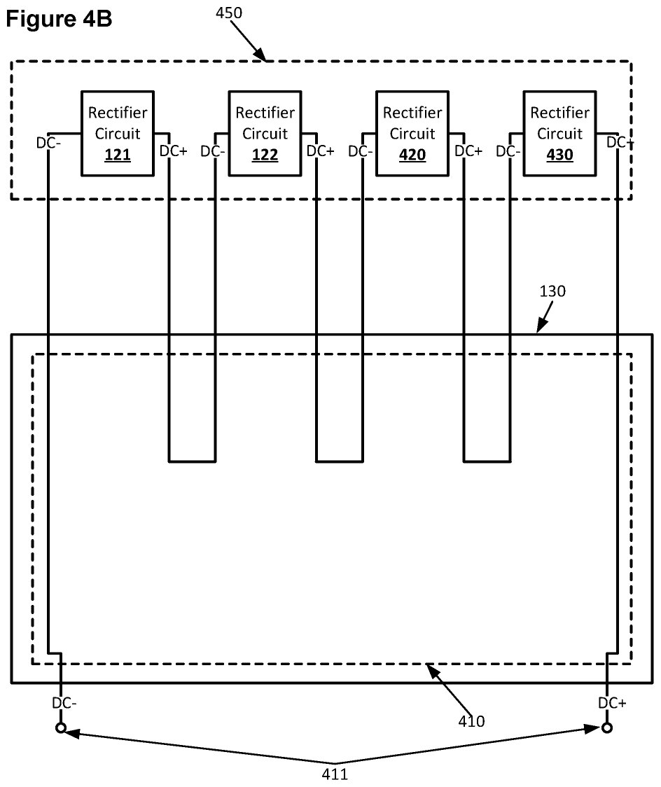

FIG. 5 shows an example system suitable for a self-powered energy harvesting circuit according to an implementation of the disclosed subject matter. Outputs from static circuit 130 may be connected to the energy storage devices, such as the energy storage devices 141, 142, 510, 520, and 530, of the energy collection pool 140. For example, each output of a group circuit of the static circuit 130 may be connected to a separate one of the energy storage devices 141, 142, 510, 520, and 530. The energy storage devices 141, 142, 510, 520, and 530 may be, for example, batteries, capacitors, super capacitors, or other energy storage devices. Each of the energy storage devices 141, 142, 510, 520, and 530 of the energy collection pool 140 may charge using the DC carried by the outputs from static circuit 130.

The energy collection pool 140 may a have single output 561. The outputs of the energy storage devices, such as the energy storage devices 141, 142, 510, 520, and 530, may be combined in serial or in parallel into the single output 561. The single output 561 may carry DC of any suitable voltage. The voltage of the DC carried by the single output 561 may vary depending on the amount of energy stored in the energy storage devices of the energy collection pool 140. The single output 561 may be split into a primary output 562 and a secondary output 563, both of which may carry DC.

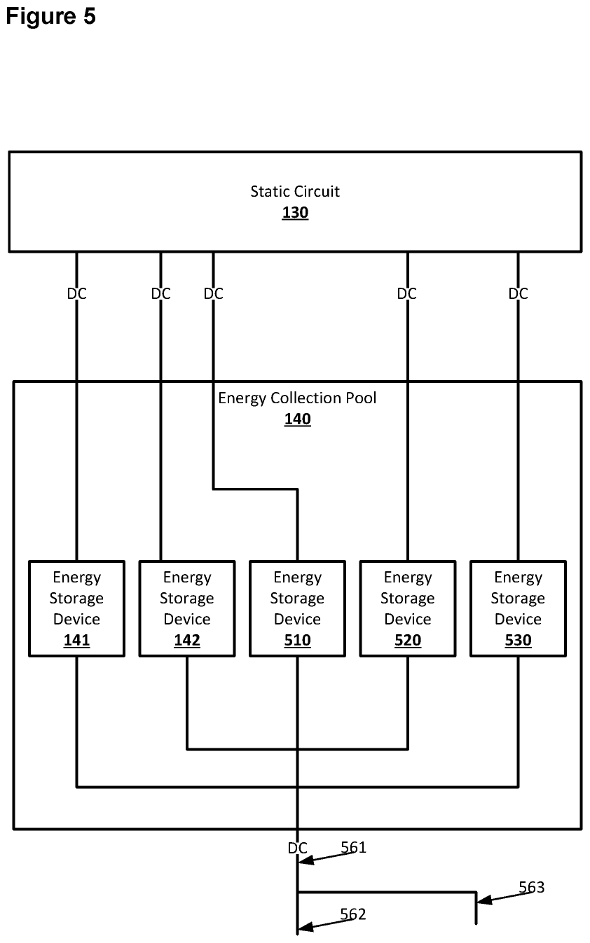

FIG. 6 shows an example system suitable for a self-powered energy harvesting circuit according to an implementation of the disclosed subject matter. The switch 150 may receive DC carried by the primary output 562 from the energy collection pool 140. When the switch 150 is closed, an output 601 may carry DC from the energy storage devices of the energy collection pool 140 to the voltage regulator 170, as the energy storage devices may discharge through the primary output 562 into an electrical load connected to an output 611 of the voltage regulator 170. When the switch 150 is closed, no DC may be carried through the switch and to the voltage regulator 170 on the output 601, and the electrical storage devices may not discharge through the primary output 562 of the energy collection pool 140 to the output 601.

The controller 160 may be any suitable controller, such as an electronic microcontroller, and may include an integrated analog-to-digital converter. The controller 160 may be powered by DC from the energy storage devices of the energy collection pool 140, received through the secondary output 563. The controller 160 may receive DC through the secondary output 563 whether or not the switch 150 is closed. The controller 160 may include a voltage regulator that may convert the DC carried on the secondary output 563 to the proper voltage for operation of the controller 160. The controller 160 may monitor the level of energy stored in the energy collection pool 140, for example, through measuring the amperage or voltage of the secondary output 563 before the DC is converted to a voltage used to operate the controller 160. A voltmeter may, for example, be connected to the secondary output 563 in parallel with the controller 160 and may measure the voltage of the DC output from the energy collection pool 140.

The controller 160 may operate the switch 150. The controller 160 may enable the switch 150, closing it, and disable the switch 150, opening it. The controller 160 may enable the switch 150, closing it, when the level of energy stored in the energy storage devices of the energy collection pool 140 reaches a predetermined level, for example, as determined based on the voltage of the DC carried by the secondary output 563. Enabling the switch 150 may allow DC to be carried from the energy collection through the primary output 562, the switch 150, and the output 601 to the voltage regulator 170. The controller 160 may disable the switch 150, opening it, when the level of energy stored in the energy storage devices of the energy collection pool 140 reaches a second predetermined level, for example, as determined based on the voltage of the DC carried by the secondary output 563. The second predetermined level of energy may be lower than the predetermined level of energy, and may be reached when the energy storage devices have discharged after that switch 150 was closed. After disabling the switch 150, the controller 160 may not enable the switch 150 again until the level of energy stored in the energy storage devices of the energy collection pool 140 again reaches the predetermined level. This may allow for an electrical load connected to the voltage regulator 170 to be burst-charged using energy collected from the transducer element array 110 by the energy storage devices of the energy collection pool 140 over any suitable period of time.

The voltage regulator 170 may receive DC carried by the output 601 from the switch 150 when the switch 150 is closed. The voltage regulator 170 may be any suitable device, component, or circuit to convert the DC output by the switch 150 to a voltage level for an electrical load connected to the voltage regulator 170. The output of the voltage regulator 170 may be the output for the self-powered energy harvesting circuit 100, and may carry DC which may be used by any suitable electric or electronic component, such as, for example, a charging circuit for a battery.

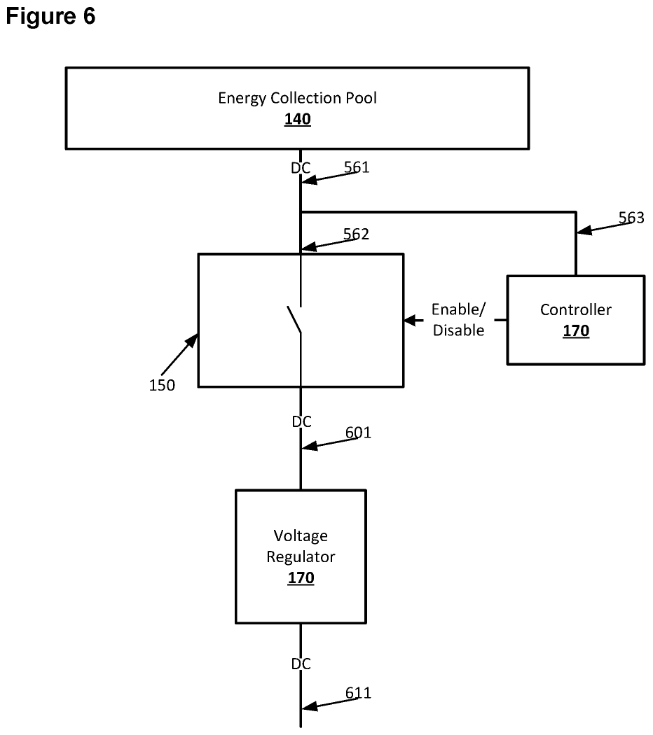

FIG. 7 shows an example arrangement suitable for a self-powered energy harvesting circuit according to an implementation of the disclosed subject matter. The controller 160 may implement a state machine which may include a switch disabled state 702 and a switch enabled state 704. The controller 160 may transition between the switch disabled state 702 and the switch enabled state 704 based on the level of energy stored in the energy storage devices of the energy collection pool 140.

When the controller 160 is in the switch disabled state 702, the switch 150 may be disabled, or open. Energy from the transducer element array 110 may be used to charge the energy storage devices of the energy collection pool 140, which may discharge small amounts of energy to the controller 160 to allow the controller 160 to operate. The controller 160 may measure the level of energy stored in the energy storage devices of the energy collection pool 140, continuously or at discrete intervals. Once the level of energy has reached a predetermined level, due to charging of the energy storage devices using energy generated by the transducer element array 110, the controller 160 may transition to the switch enabled state 704 by enabling the switch 150, closing it.

When the controller 160 is in the switch enabled state 704, the switch 150 may be enabled, or closed. Energy from the energy storage devices of the energy collection pool 140 may burst-charge an electrical load connected to the voltage regulator 170 through the closed switch 150, discharging larger amounts of energy from the energy storage devices. The controller 160 may measure the level of energy stored in the energy storage devices of the energy collection pool 140, continuously or at discrete intervals. Once the level of energy has reached a second predetermined level, lower than the predetermined level, due to discharging of the energy storage devices into the electrical load connected to the voltage regulator 170, the controller 160 may transition to the switch disabled state 702 by disabling the switch 150, opening it.

The controller 160 may cycle between the switch disabled state 702 and the switch enabled state 704 as the level of energy stored in the energy storage devices of the energy collection pool 140 rises and falls. The controller 160 may spend more time in the switch disabled state 702 than in the switch enabled state 704, as the transducer element array 110 may generate small amounts of energy that may be collected in the energy storage devices of the energy collection pool 140 over time while the switch 150 is open, and the stored energy may be discharged quickly from the energy storage devices of the energy collection pool 140 into an electrical load connected to the voltage regulator 170 when the switch 150 is closed, burst-charging the electrical load, which may be, for example, a battery.

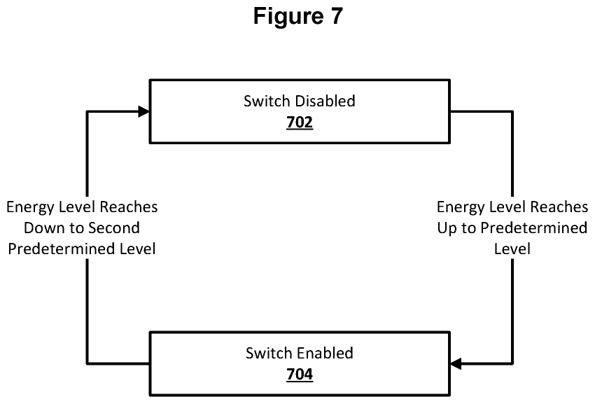

Embodiments of the presently disclosed subject matter may be implemented in and used with a variety of component and network architectures. FIG. 8 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

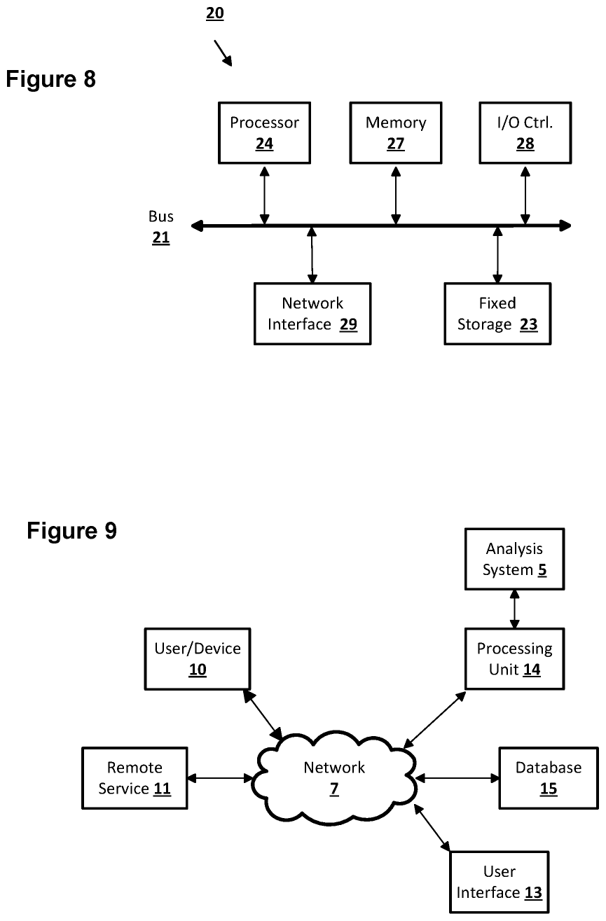

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 9.

Many other devices or components (not shown) may be connected in a similar manner, such as document scanners, digital cameras, auxiliary, supplemental, or backup systems, or the like. Conversely, all of the components shown in FIG. 8 need not be present to practice the present disclosure. The components can be interconnected in different ways from that shown. The operation of a computer such as that shown in FIG. 8 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 9 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A self-powered energy harvesting circuit device comprising:
a power generating mechanism comprising power generating elements configured to generate alternating current signals;
one or more rectifier circuits, each of the rectifier circuits comprising a rectifier configured to generate a direct current signal from an alternating current signal;
one or more group circuits, each of the group circuits connecting a group of the rectifier circuits in an electrical circuit to combine the direct current signals from the rectifier circuits in the group into a single direct current signal;
one or more energy storage devices, each of the energy storage devices connected to at least one of the group circuits, the outputs of the one or more energy storage devices combined into a single output, the single output split into a primary output and a secondary output;
a switch connected to the primary output;
a controller connected to the secondary output and to the switch and configured to control the switch; and
a voltage regulator connected to an output of the switch.

2. The device of claim 1, wherein the voltage regulator is connected to a battery.

3. The device of claim 1, wherein the controller is configured to control the switch by opening the switch and closing the switch.

4. The device of claim 3, wherein the controller is further configured to measure a level of energy stored in the energy storage devices, close the switch when the level of energy reaches a predetermined level, and open the switch when the level of energy reaches a second predetermined level that is lower than the predetermined level.

5. The device of claim 1, wherein the direct current signals from the one or group circuits have varying voltages.

6. The device of claim 1, wherein the energy storage devices comprise one or more of capacitors, supercapacitors, and batteries.

7. The device of claim 1, wherein the power generating elements are connected to the one or more rectifier circuits.

8. The device of claim 1, wherein the power generating mechanism comprises a transducer array, and wherein the power generating elements comprise transducers.

9. The device of claim 8, wherein the transducer array is an ultrasonic transducer array, and wherein the transducers are ultrasonic transducers.

10. The device of claim 1, wherein each of the one or more rectifier circuits is connected to a single power generating element.

11. A self-powered energy harvesting circuit device comprising:
a power generating mechanism comprising power generating elements configured to generate alternating current signals;
one or more rectifier circuits connected to the power generating elements, each of the rectifier circuits comprising a rectifier configured to generate a direct current signal from the alternating current signals generated by the power generating elements;
one or more group circuits, each of the group circuits connecting a group of the rectifier circuits in an electrical circuit to combine the direct current signals from the rectifier circuits in the group into a single direct current signal;
one or more energy storage devices, each of the energy storage devices connected to at least one of the group circuits, wherein the one or more energy storage devices store energy carried by the direct current signals output by the one or more group circuits, the outputs of the one or more energy storage devices combined into a single output carrying a direct current signal, the single output split into a primary output carrying a direct current signal and a secondary output carrying a direct current signal;
a switch connected to the primary output and comprising an output that carries the direct current signal from the primary output when the switch is closed;
a controller connected to the secondary output and to the switch, and operating using the direct current signal carried by the secondary output, and configured to control the switch based on a level of energy stored in the energy storage devices; and
a voltage regulator connected to the output of the switch and comprising an output that carries a direct current signal converted from the direct current signal from the output of the switch to a voltage for an electrical load when the switch is closed.

12. The device of claim 11, wherein the electrical load is a battery.

13. The device of claim 11, wherein the controller is configured to control the switch by opening the switch and closing the switch.

14. The device of claim 13, wherein the controller is further configured to measure the level of energy stored in the energy storage devices, close the switch when the level of energy reaches a predetermined level, and open the switch when the level of energy reaches a second predetermined level that is lower than the predetermined level.

15. The device of claim 11, wherein the direct current signals from the one or group circuits have varying voltages.

16. The device of claim 11, wherein the energy storage devices comprise one or more of capacitors, supercapacitors, and batteries.

17. The device of claim 11, wherein the power generating elements are connected to the one or more rectifier circuits.

18. The device of claim 11, wherein the power generating mechanism comprises a transducer array, and wherein the power generating elements comprise transducers.

19. The device of claim 18, wherein the transducer array is an ultrasonic transducer array, and wherein the transducers are ultrasonic transducers.

20. The device of claim 11, wherein each of the one or more rectifier circuits is connected to a single power generating element.
